(19) United States
(12) Patent Application Publication
(10) Pub. No.: US 2025/0197177 A1
(43) Pub. Date: Jun. 19, 2025

(54) LIFTING DEVICE

(71) Applicant: INNIO Jenbacher GmbH & Co OG, Jenbach (AT)

(72) Inventors: Lukas Grasl, Tyrol (AT); Johannes Dengg, Tyrol (AT)

(21) Appl. No.: 18/981,432

(22) Filed: Dec. 13, 2024

(30) Foreign Application Priority Data
Dec. 14, 2023 (DE) DE102023135239.3

(51) Int. Cl. B66F 7/28; F16F 15/12

(52) U.S. Cl. CPC B66F 7/28; F16F 15/1203

(57) ABSTRACT

A lifting device for, in particular, disk-shaped bodies, in particular vibration dampers, having a base element and a receiving element, wherein the receiving element comprises a frame-shaped holding element for the temporary mounting of the, in particular, disk-shaped body, and the receiving element is connected to the base element via a rotary bearing and a drive device, in particular a linear drive, which is arranged so as to act between the base element and the receiving element, wherein the holding element has at least one rotatably mounted support element for the, in particular, disk-shaped body.

### CROSS-REFERENCE TO RELATED APPLICATION

This application claims priority to and benefit of German Application No. DE102023135239.3, filed on Dec. 14, 2023, entitled “LIFTING DEVICE”, which is herein incorporated by reference in its entirety.

### FIELD OF THE INVENTION

The invention relates to a lifting device, in particular for disk-shaped bodies, in particular vibration dampers, comprising a base element and a receiving element, wherein the receiving element comprises a frame-shaped holding element for temporarily supporting the disk-shaped body, and the receiving element is connected to the base element via a rotary bearing and a drive device, in particular a linear drive, which is arranged so as to act between the base element and the receiving element.

### BACKGROUND

A lifting device of the generic type is represented, for example, by the lawn tractor lifter from MASKO. To lift the lawn tractor, the lifting device is positioned under the tractor and, as a result, the support frame is tilted by means of a spindle drive about the common rotary bearing relative to the base frame, so that the underside of the tractor is accessible for cleaning and maintenance work.

The known lifting devices are severely restricted in their fields of application because of their design, which is why the object of the invention is to provide a lifting device which is improved in comparison with the prior art and which can be handled more flexibly both with respect to the bodies to be lifted and with respect to the place of use.

### BRIEF DESCRIPTION

This is achieved in the lifting device according to the invention in that the holding element has at least one rotatably mounted support element for the, in particular, disk-shaped body.

This makes it possible to move the body, in particular to rotate it, even when the lifting device is in a lifting position, as a result of which it is achieved that the position of the raised body can be adapted accordingly for maintenance and/or assembly work.

It has also proved to be particularly advantageous if—viewed in a longitudinal section—the bearing plane of the holding element is spaced vertically from the bearing axis of the rotary bearing.

In other words, the bearing plane of the holding element is spaced apart from the plane of the base element, so that, on the one hand, the tilt angle can be kept smaller and, on the other hand, accessibility to the entire underside of the holding element and thus to the raised body—in contrast to the lifting devices of the prior art—is provided to a sufficient extent.

A preferred exemplary embodiment of the invention provides that the holding element has a passage opening for receiving the disk-shaped body, wherein in each case at least one rotatably mounted support element is arranged in two opposite end portions of the passage opening in such a way that the passage opening is delimited by the opposite support elements.

In other words, the essentially planar holding element, which can be designed, for example, as a quadrangular frame, has an opening into which the body to be lifted projects at least partially, so that the body to be lifted not only rests on the supporting elements of the holding element, but is additionally surrounded at least in regions by the holding element, as a result of which a secure holding of the body, in particular against lateral tilting, is achieved with simultaneous rotational mobility of the body.

Tests carried out by the applicant have shown that the ratio between secure holding and simultaneous rotational mobility of the body to be lifted is achieved particularly well when the longitudinal extent of the clear opening of the passage opening remaining between the opposing support elements is between 65 and 98 percent, preferably between 85 and 96 percent, of the diameter of a disk-shaped body.

According to a further exemplary embodiment of the invention, it is provided that at least two opposing support elements are formed by running bodies with substantially parallel axes, as a result of which a technically simple and cost-effective implementation of the rotatability of the support elements is provided.

In order to be able to keep the tilt angle small, a further preferred exemplary embodiment of the invention provides that the receiving element has at least one rod which is connected to the holding element in a substantially flexurally rigid manner and the end portion of which, facing away from the holding element, forms the rotary bearing together with a corresponding portion of the base element.

The rod, which according to a further exemplary embodiment is connected substantially at right angles to the holding element, thus creates a spacing between the holding element and the base element, so that the holding element—starting from a position substantially parallel to the base element—can also be lowered in the direction of the base element on its end portion facing the drive device.

In this way, on the one hand, the angle of inclination can be kept smaller, as a result of which the stability of the mounted body is enormously increased, and, on the other hand, the holding element can be inclined or lowered in the direction of the base element starting from a position parallel to the base element.

If, according to a further exemplary embodiment of the invention, the length of the rod is between 45 and 85 percent, preferably between 55 and 70 percent, of the radius of the, in particular, disk-shaped body, improved accessibility to the raised body from below is provided.

According to an exemplary embodiment of the invention, it is provided that the drive device is formed by a spindle drive, while another exemplary embodiment of the invention provides that the drive device is formed by a hydraulic lifting drive.

It should be noted at this point that a wide variety of types of drive devices are suitable for implementing the idea of the invention, but the two aforementioned drive devices have proved to be particularly practical in the applicant's tests.

In order to be able to ensure a transport of a body to be lifted with the lifting device according to the invention from one location to another, it is provided according to a preferred exemplary embodiment of the invention that the lifting device is designed as a track-bound conveying means with a chassis, a chassis and a track-providing guide device.

A technically simple solution is achieved if the base element forms the chassis and the chassis has at least two parallel axles with running bodies.

If the track-bound guide device comprises a preferably stationary running rail, a simple and reliable transport of the lifting device along the rails is ensured. In this case, it has also been found to be advantageous if the running bodies are not steerable.

As provided by a further exemplary embodiment of the invention, the guide device has fastening means for positioning the lifting device on a machine and/or preferably height-adjustable support elements for temporarily positioning the lifting device on the passageway.

The fastening means and the support element make it possible for the track-bound guide device to be positioned at a distance from the ground, for example on a machine. Thus, a guide device is obtained which is in fact floor-independent, but still operates like a floor-bound guide device.

A particularly preferred exemplary embodiment of the lifting device according to the invention further provides that the receiving element is designed to temporarily mount the, in particular, disk-shaped body, and the base element is designed such that the receiving element, together with the body mounted thereon, can be moved at least linearly for moving out of and into a machine region, wherein a simple positioning of the mounted body in different positions can be achieved when the receiving element is designed for the rotatable mounting of the disk-shaped body.

The lifting device according to the invention ensures safe and simple handling with little effort. The body, which is for example a disk-shaped vibration damper of a gas engine, can be raised and/or lowered, freely rotated through 360° and axially displaced. Due to the slim design of the lifting device, it is possible to use it even in the narrowest space. Thus, for example, a vibration damper of a gas engine can be replaced without other machine components having to be removed. Complex solutions which are questionable in terms of safety, such as, for example, laying a rail system on a machine frame, on which rail system a lifting block for lowering the vibration damper is arranged in a movable manner, can be avoided with the invention.

### BRIEF DESCRIPTION OF THE DRAWINGS

Further details and advantages of the present invention are explained in more detail below based on the description of the figures with reference to the exemplary embodiments shown in the drawings.

FIG. 1 shows a preferred exemplary embodiment of the invention, in which the lifting device is designed as a track-bound conveying means with a track-providing guide device,

FIG. 2a shows the exemplary embodiment of FIG. 1 with a body mounted thereon,

FIG. 2b shows the arrangement of the lifting device according to the invention on a machine,

FIGS. 3a, 3b show a front view and a perspective view of a body mounted on a lifting device according to the invention in the lowered position of the lifting device,

FIGS. 4a, 4b show the example of FIGS. 3a and 3b in a lifting position of the lifting device; and

FIGS. 5a-5c show different positions of the lifting device with body mounted thereon during disassembly of the body from a machine.

### DETAILED DESCRIPTION

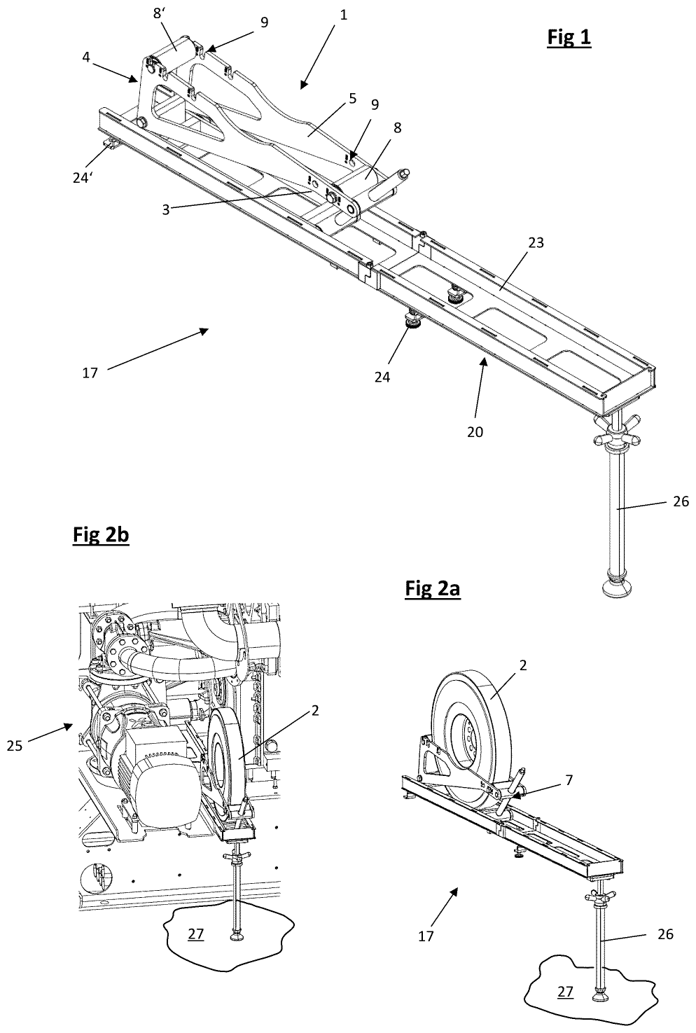

The lifting device 1 shown in FIG. 1 is designed as a track-bound conveying means 17. In this case, the base element 3 of the lifting device 1 is arranged movably in a rail 23 of the track-bound guide device 20.

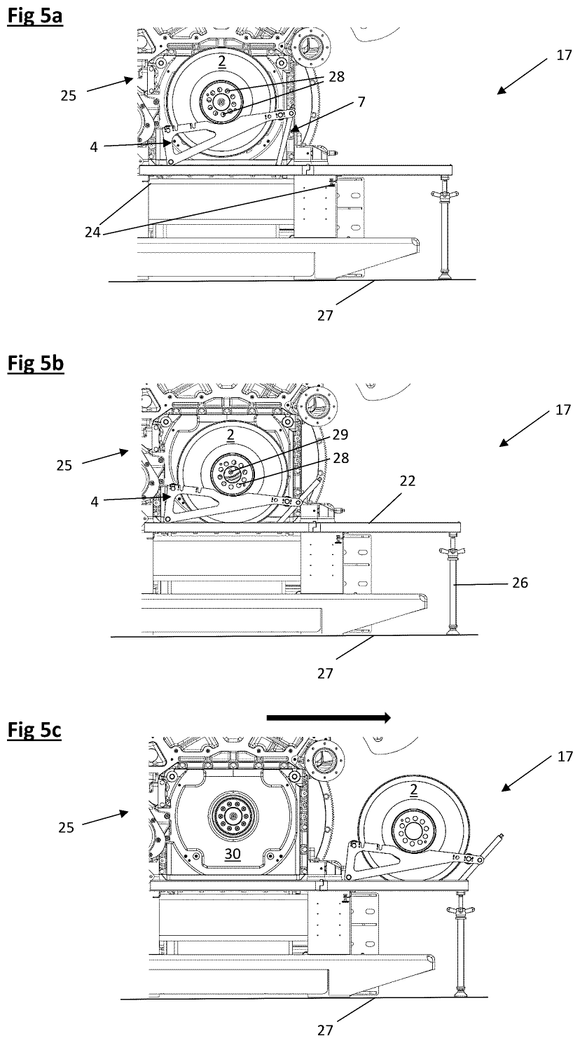

The guide device 20 has fastening means 24, 24′ for temporarily fixing the guide device 20 to a machine 25 (FIGS. 5a-5c) and a height-adjustable supporting element 26, by means of which the guide device 20 is supported on the floor.

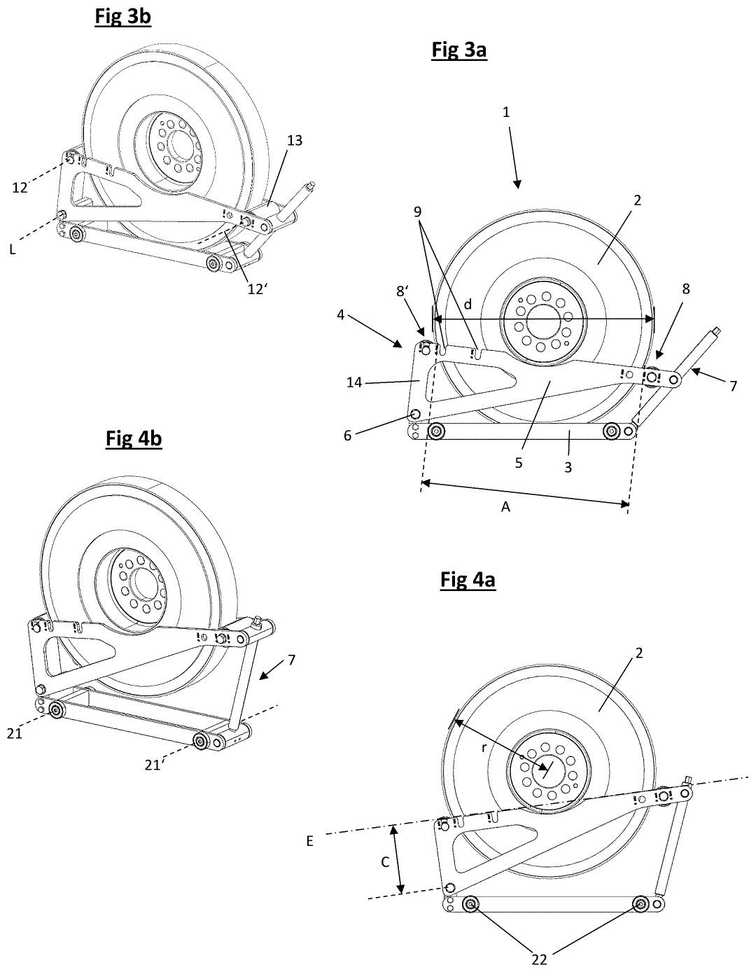

The receiving element 4 is connected to the base element 3 in an end region via a rotary bearing 6 (FIG. 3a) and on its opposite side via a linear drive device 7. The receiving element 4 comprises a frame-shaped holding element 5 which has, in two opposite end portions, two rotatably mounted support elements 8, 8′ for the body 2 to be lifted.

FIG. 2a shows the lifting device from FIG. 1, which is supported on the floor 27. A body 2, in the exemplary embodiment shown a disk-shaped vibration damper, is mounted on the lifting device 1, which is constructed as a track-bound conveying means 17. The lifting device 1 is in the lowered state, i.e. the body 2 was lowered by means of the linear drive device 7. In this position, the body 2 supported on the holding element 4 can now be moved axially in the track-bound guide device 20.

FIG. 2b shows the arrangement of a lifting device 1 in the form of a track-bound conveying means 17 on a machine 25, wherein—starting from the position shown in FIG. 2a—the body 2 has been moved out of the machine 25, so that the body 2 is now freely accessible and can be transported away, for example, by means of a lifting crane. It can be seen that the lifting device 1 is very narrow, on the one hand in order to be able to get into the machine 25 under the body 2, for example a vibration damper, and on the other hand, even if several bodies 2 are arranged next to one another in the machine 25, the bodies 2 can be removed or picked individually from the machine 25.

In the exemplary embodiment of the lifting device 1 according to the invention shown in FIGS. 3a and 3b, the holding element 4 is connected to the base element 3 in a radially movable manner in an end region via a rotary bearing 6. At the opposite end, the receiving element 4 is connected to the base element 3 via a linear drive 7. This linear drive 7 can be designed, for example, as a spindle drive or hydraulic lifting drive.

The body 2 is mounted on the holding element 5 of the receiving element 4. The body 2 rests on the rotatable support elements 8, 8′. An essential feature is that multiple receiving openings 9 for the support elements 8, 8′ are formed in the holding element 5. Thus, on the one hand, bodies 2 of different sizes can be accommodated with the lifting device 1 according to the invention and, on the other hand, the position, in particular the height, of the bodies 2 can be influenced via the positioning in the holding element 5.

The holding element 5 has a trough-shaped recess, as a result of which accessibility to the passage openings 28 of the body 2 is ensured, which openings are for receiving connecting elements (not shown) by means of which the body 2 is fastened to the machine 25.

FIGS. 4a and 4b show the lifting device 1 of FIGS. 3a and 3b in the lifting position. By means of the drive device 7, the frame-shaped holding element 5 was moved upwards relative to the base element 3, so that the body 2 now rests only on the rotatably mounted support elements 8, 8′ and is mounted freely rotatably through 360° in this position of the lifting device 1. Since the longitudinal extent A of the clear opening between the support elements 8, 8′ is somewhat smaller than the diameter d of the disk-shaped body 2, it is ensured that the body 2 is supported in a stable manner.

The length c of the rod 14, which defines the distance between the bearing axis L of the rotary bearing 6 and the bearing plane E of the holding element 5, is approximately ⅔ of the radius r of the body 2. As a result, the tilt angle between the raised and lowered positions of the body 2 can be kept small, which in turn has a positive effect on the stability of the mounted body 2.

The body 2 thus lifted can now be freely rotated through 360°, which is important in order to bring the passage openings 28 in the body 2 into alignment with corresponding receiving openings 29 (FIG. 5c) on the machine 25, so that the body 2 can be fastened by means of connecting elements (not shown), for example screws, which are introduced through the passage openings 28 into the receiving openings 29 on the machine 25.

In the exemplary embodiment shown, the base element 3 forms the chassis 18 of the track-bound conveying means 17, wherein the carriage 19 comprises two parallel axles 21, 21′ with running bodies 22.

FIGS. 5a-5c show different positions of the lifting device 1 according to the invention with the body 2 mounted thereon during the disassembly of the body 2 from a machine 5.

In FIG. 5a, the disk-shaped body 2, which is formed by a vibration damper, is fastened to the machine 25, in particular to the crankshaft of the machine 25. The holding element 5 of the lifting device 1, which is constructed as a track-bound conveying means 17, has been brought to rest on the body 2 via the drive device 7 in such a way that the body 2 rests on the rotatably mounted receiving elements 8, 8′. In this position, the connecting elements with which the body 2 is arranged on the machine 25 are now removed.

The body 2, which is now decoupled from the machine 25 and mounted on the holding element 5, is subsequently lowered by means of the drive device 7. It can be seen from FIG. 5b that in this position the passage openings 28 in the body 2 are no longer congruent with the receiving openings 29 on the machine 25.

By means of the carriage 19 (running body 22 from FIG. 4a), the lifting device 1 is now moved out of the machine 25 in the direction of the arrow in the rail 23 of the guide device 20. The guide device 20 rests on the machine 25 in the region of the latter and is supported on the floor 27 outside the machine region via a supporting element 26.

In the position shown in FIG. 5c, the body 2 is freely accessible and can be transported away, for example, by means of a crane, which is not possible due to the inaccessibility to the mounting position of the body 2 in the machine 25.

The mounting of a replacement body 2 is carried out in the reverse order, wherein the 360° rotatable mounting of the body 2 on the rotatably mounted receiving elements 8, 8′ of the holding element 5 is in particular again pointed out, because it is only by this rotatability that it is ensured that the body 2, when it is in the lifting position according to FIG. 5a, can be rotated in a simple manner until the passage openings 28 in the body 2 can be brought into alignment with the receiving openings 29 on the machine 25, in the case of vibration dampers on the crankshaft of the machine 25, so that the fastening of the replacement body 2 to the machine 25 can be effected in a simple manner.

Although the invention has been specifically described using the exemplary embodiment shown, it goes without saying that the subject matter of the application is not limited to this exemplary embodiment. Measures and modifications that serve to implement the inventive idea are entirely conceivable and desirable. Thus, for example, the drive device could also be formed by a hydraulic lifting drive or a rack instead of a spindle drive. Also with regard to the design of the track-bound conveying means, in particular the guide device, the invention is in no way limited as long as the lifting device with the body mounted thereon can be moved out of the machine region in a simple manner and thus it is ensured that the body is subsequently freely accessible.

### LIST OF REFERENCE NUMBERS

1 lifting device
2 disk-shaped body
3 base element
4 receiving element
5 holding element
6 rotary bearing
7 drive device
8 support element
9 receiving openings
14 rod
17 track-bound conveying means
18 chassis
19 carriage
20 guide device
21 axles
22 running body
23 rail
24 fastening means
25 machine
26 supporting element
27 floor
28 passage openings
29 receiving openings
E bearing plane of 5
L bearing axis of 6
A longitudinal extension of the clear opening of 5
c length of 14
d diameter of 2
r radius of 2

1. A lifting device for disk-shaped bodies comprising vibration dampers, comprising:
a base element; and
a receiving element, wherein the receiving element comprises a frame-shaped holding element for the temporary mounting of a disk-shaped body, the receiving element is connected to the base element via a rotary bearing and a drive device comprising a linear drive, the drive device is configured to act between the base element and the receiving element, and the frame-shaped holding element has at least one rotatably mounted support element for the disk-shaped body.

2. The lifting device according to claim 1, wherein—viewed in a longitudinal section—a bearing plane of the frame-shaped holding element is spaced vertically from a bearing axis of the rotary bearing.

3. The lifting device according to claim 1, wherein the frame-shaped holding element has a passage opening for receiving the disk-shaped body, wherein the at least one rotatably mounted support element comprises opposing support elements arranged in two opposite end portions of the passage opening such that the passage opening is delimited by the opposing support elements.

4. The lifting device according to claim 3, wherein a longitudinal extent of a clear opening portion of the passage opening remaining between the opposing support elements is between 65 and 98 percent of a diameter of the disk-shaped body.

5. The lifting device according to claim 3, wherein the opposing support elements are formed by running bodies with substantially parallel axes.

6. The lifting device according to claim 1, wherein the receiving element has at least one rod connected to the frame-shaped holding element in a substantially flexurally rigid manner, and an end portion of the at least one rod facing away from the frame-shaped holding element and a corresponding portion of the base element forms the rotary bearing.

7. The lifting device according to claim 6, wherein the rod is connected to the frame-shaped holding element substantially at right angles.

8. The lifting device according to claim 6, wherein the length of the rod is between 45 and 85 percent of a radius of the disk-shaped body.

9. The lifting device according to claim 1, wherein the drive device comprises a spindle drive.

10. The lifting device according to claim 1, wherein the drive device comprises a lift drive.

11. The lifting device according to claim 1, wherein the lifting device comprises a track-bound conveyor having a chassis, a carriage, and a track guide.

12. The lifting device according to claim 11, wherein the base element forms the chassis and the carriage has at least two parallel axles with running bodies.

13. The lifting device according to claim 11, wherein the track guide comprises a location-unbound rail.

14. The lifting device according to claim 1, wherein the track guide has one or more fasteners for positioning the lifting device on a machine and/or at least one height-adjustable supporting element for temporarily positioning the lifting device on a floor.

15. The lifting device according to claim 1, wherein the receiving element is designed to temporarily mount the disk-shaped body, and the base element is configured such that the receiving element, together with the disk-shaped body mounted thereon, can be moved at least linearly for moving out of and into a machine region.

16. The lifting device according to claim 1, wherein the receiving element is designed for a rotatable mounting of the disk-shaped body.

17. A method for lifting disk-shaped bodies comprising vibration dampers, comprising:
temporarily mounting a disk-shaped body via a frame-shaped holding element of a receiving element of a lifting device, wherein the receiving element is connected to a base element
enabling rotation between the receiving element and a base element of the lifting device via a rotary bearing and a drive device comprising a linear drive, wherein drive device is configured to act between the base element and the receiving element; and
rotatably supporting the disk-shaped body via at least one rotatably mounted support element of the frame-shaped holding element.

18. The method of claim 17, comprising receiving the disk-shaped body in a passage opening in the frame-shaped holding element.

19. The method of claim 17, wherein drive device comprises at least one of a spindle drive, a lift drive, or a track-bound conveyor having a chassis, a carriage, and a track guide.

20. The method of claim 17, comprising moving the receiving element and the disk-shaped body at least linearly for moving out of and into a machine region.
